(19) United States
(12) Patent Application Publication
(10) Pub. No.: US 2016/0349901 A1
(43) Pub. Date: Dec. 1, 2016

(54) TOUCH SCREEN, TOUCH DISPLAY PANEL AND TOUCH DEVICE

(71) Applicants: SHANGHAI TIANMA MICRO-ELECTRONICS CO., LTD., Shanghai (CN); TIANMA MICRO-ELECTRONICS CO., LTD., Shenzhen (CN)

(72) Inventors: Xiaoye Li, Shanghai (CN); Feng Lu, Shanghai (CN); Shaofa Lan, Shanghai (CN)

(21) Appl. No.: 15/081,957

(22) Filed: Mar. 28, 2016

(30) Foreign Application Priority Data
May 29, 2015 (CN) 201510289541.5

(51) Int. Cl. G06F 3/041; G06F 3/044

(52) U.S. Cl. CPC G06F 3/0416; G06F 3/044; G06F 3/0412

(57) ABSTRACT

The present disclosure discloses a touch screen, a touch display panel and a touch device. The touch screen or the touch display panel includes: a plurality of touch sensing electrodes arranged in an array and insulated from each other; a plurality of touch sensing leads, each of which is electrically connected with one of the touch sensing electrodes. The touch screen or the touch display panel includes a rectangle active touch region, wherein a total number of the touch sensing electrodes within the rectangle active touch region is larger than or equal to 3.175p and is smaller than or equal to 126p², wherein p represents a size of the rectangle active touch region, is in a unit of inch and is a positive integer. The touch screen, the touch display panel or the touch device can improve touch accuracy.

### CROSS-REFERENCES TO RELATED APPLICATIONS

This application claims priority to a Chinese patent application No. 201510289541.5 filed on May 29, 2015 and entitled “Touch Screen, Touch Display Panel And Touch Device”, the disclosure of which is incorporated herein by reference in its entirety.

### TECHNICAL FIELD

The present disclosure relates to the field of display technologies, in particular to a touch screen, a touch display panel and a touch device.

### BACKGROUND

As an input medium, a touch screen has been the simplest, most convenient and natural human-machine interaction manner, and has been paid attention by more and more flat-panel display manufacturers to integrate a touch function on a liquid crystal display (LCD) or an organic light emitting diode (OLED).

In order to further reduce volume of a touch display panel, such as decrease thickness of a mobile terminal provided with the touch display panel, an In-Cell Touch Panel (In-Cell TP) technology has been developed in the display field recently. The In-Cell TP technology is to integrate a touch sensing electrode within a liquid crystal display panel, and thus the touch screen manufactured by using In-Cell TP technology is lighter and thinner than that manufactured by using One Glass Solution (OGS).

Additionally, there is a need to improve touch accuracy of the touch screen or the touch display panel. The touch accuracy is related to many factors of the touch screen or the touch display panel, such as a touch manner (e.g. a self-capacitive touch or a mutual-capacitive touch), a shape and a size of the touch sensing electrode, and a form for touch driving.

### SUMMARY

In view of this, the present disclosure provides a touch screen, a touch display panel and a touch device.

The present disclosure provides a touch screen. The touch screen, which is a self-capacitive touch screen, includes: a plurality of touch sensing electrodes arranged in an array and insulated from each other; a plurality of touch sensing leads, each of which is electrically connected with one of the touch sensing electrodes; and there is a rectangle active touch region in the touch screen such that a total number of the touch sensing electrodes within the rectangle active touch region is larger than or equal to 3.175p and is smaller than or equal to 126p², wherein p represents a size of the rectangle active touch region, is in a unit of inch and is a positive integer.

The present disclosure further provides a touch display panel, wherein the touch display panel is a self-capacitive touch display panel, the touch display panel includes: a plurality of touch sensing electrodes arranged in an array and insulated from each other; a plurality of touch sensing leads, each of which is electrically connected with one of the touch sensing electrodes; and there is a rectangle active touch region in the touch screen such that a total number of the touch sensing electrodes within the rectangle active touch region is larger than or equal to 3.175p and is smaller than or equal to 126p², wherein p represents a size of the rectangle active touch region, is in a unit of inch and is a positive integer.

The present disclosure further provides a touch device, including the touch screen or the touch display panel as mentioned above.

### DESCRIPTION OF DRAWINGS

FIG. 1 is a top view showing a touch screen provided by an embodiment of the present disclosure;

FIG. 2 is a graph showing a variation tendency of the change value of the capacitance caused by the touch area of a stimulation finger having a diameter of 5 m over a size of an area of the touch sensing electrode;

FIG. 3 is a partially schematic diagram showing a touch screen provided by the present disclosure;

FIG. 4A is a cross-sectional view of a touch display panel provided by the present disclosure;

FIG. 4B is a top view of a touch display panel provided by the present disclosure; and

FIG. 5 shows an arrangement manner of touch sensing leads provided by an embodiment of the present disclosure.

### DETAILED DESCRIPTION OF THE EMBODIMENTS

In order to explain the technical solution of the present disclosure in more detail, specific embodiments are illustrated below in conjunction with the accompanying drawings. However, specific embodiments and drawings described herein are not used for limiting the present disclosure. Various modification and variations can be made to the present disclosure by those skilled in the art without departing from the spirit and scope of the present disclosure. Accordingly, the scope of the protection of the present invention should be subject to the appended claims.

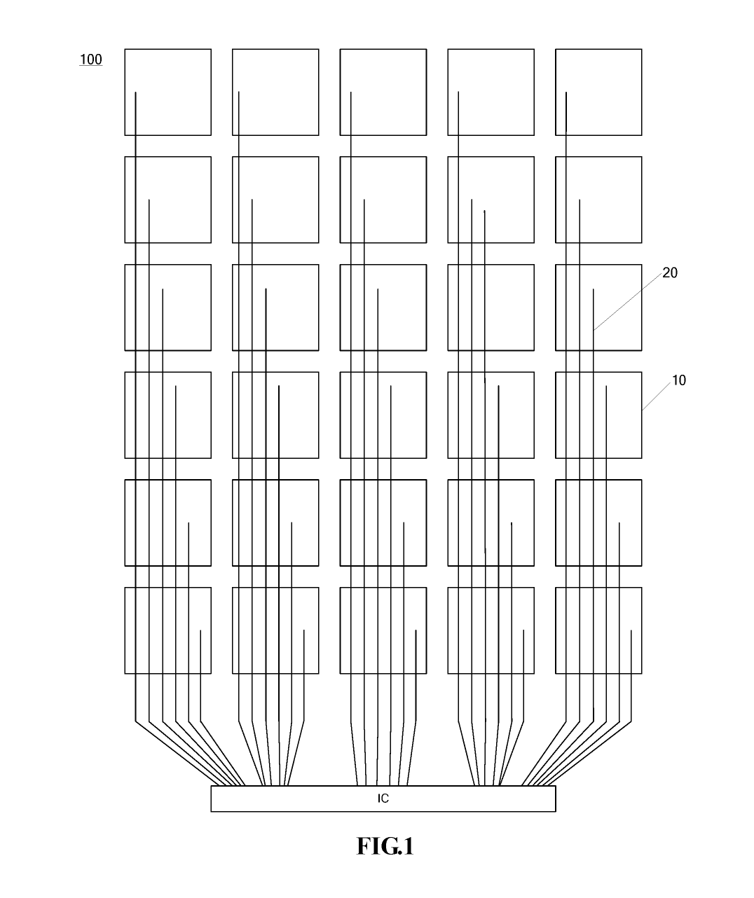

FIG. 1 is a top view showing a touch screen according to an embodiment of the present disclosure. As shown in FIG. 1, the touch screen 100 of the present disclosure includes: a plurality of touch sensing electrodes 10 arranged in an array and insulated from each other; and a plurality of touch sensing leads 20, each of which is electrically connected with one of the plurality of touch sensing electrodes 10. The touch screen 100 is a self-capacitive touch screen. A touch sensing signal is outputted into the touch sensing electrode 10 via the touch sensing lead 20. When a touch object, such as a finger, is close to the touch sensing electrode 10, a coupling capacitor is formed between the finger and the touch sensing electrode 10 due to a human-body electric field, and the formed coupling capacitor may cause a change of a capacitance of the touch sensing electrode 10 itself to the ground. It can be determined, by detecting the change of the capacitance, which one of the touch electrodes 10 is closed by the finger, and thereby a touched position of the finger can be determined.

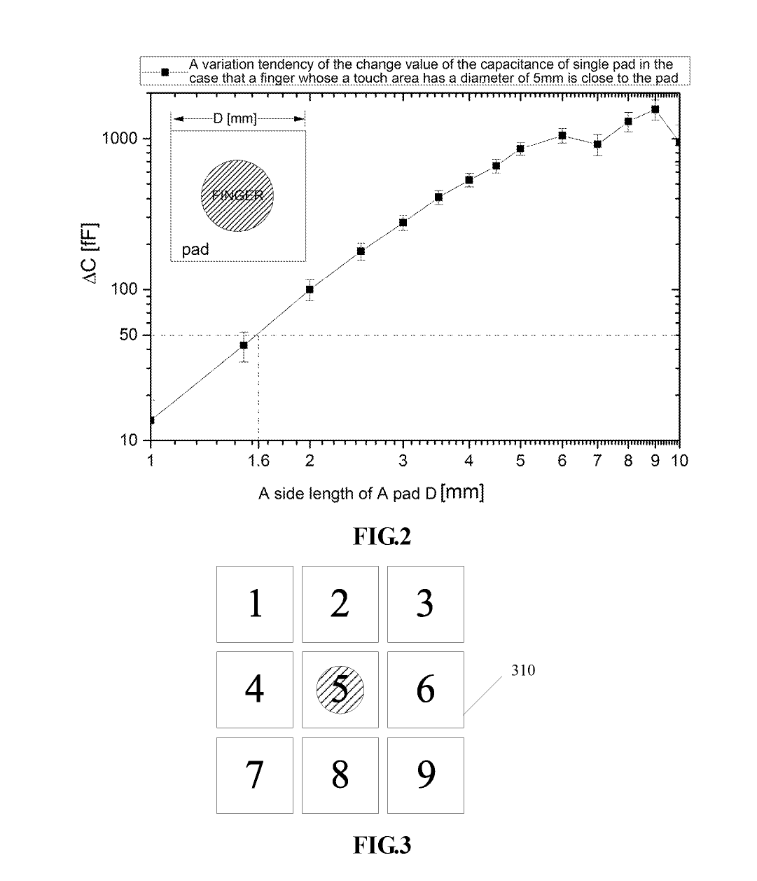

Illustratively, a finger is used as a touch object. Since whether the finger is close or not is determined by detection for the change of the capacitance on the touch sensing electrode, the change of the capacitance must be large enough in order to make an accurate detection. In general, a touch area of the finger on the touch screen is approximately equal to an area of a circle having a diameter of 5 mm, and thus the touch area of the finger can be simplified as a circle having a diameter of 5 mm, as shown at the top-left corner of FIG. 2. In order to make a simulation to acquire visual data, the touch sensing electrode can be simplified as a square shape. FIG. 2 is a graph showing a variation tendency of the change value of the capacitance caused by the touch area of a stimulation finger having a diameter of 5 m over a size of an area of the touch sensing electrode. On a basis of excluding other conditions, it is stimulated that finger is close to the touch sensing electrode, and hence the variation tendency of the change value of the capacitance on the touch sensing electrode (such as a pad) over the size of area of the touch sensing electrode is obtained. As shown in FIG. 2, the change value of the capacitance tends to larger substantially as the area of the touch sensing electrode is larger. The change value of the capacitance, which can be detected accurately without any noise according to identifiable demands, is at least 50 fF, and hence the touch sensing electrode is correspondingly a square shape having a side length of 1.6 mm or above, and then the touch area of the finger is larger than that of the touch sensing electrode, so that the finger can completely cover the touch sensing electrode, i.e. the touch area of the finger on the touch sensing electrode cannot be smaller than 2.56 mm². The touch sensing electrode may have a variety of shapes, such as a square shape, a rectangle shape, a circle shape or any polygon, but the touch surface of the finger usually is a circle or an ellipse. Therefore, in the extreme case that the finger can cover entire touch sensing electrode, the area of the touch sensing electrode cannot be smaller than 2.56 mm². If the length of the shape of the touch sensing electrode in a certain direction is beyond the coverage area of the finger, the area of the touch sensing electrode should be larger than 2.56 mm² such that the touch area of the finger on the touch sensing electrode can be at least 2.56 mm². The shape of the touch sensing electrode may also be a rectangle shape, and likewise, in order to ensure the touch area of 2.56 mm² in the case that a touched region is parallel to the touch sensing electrode, it can be configured that the length and width of the rectangle both are larger than or equal to 1.6 mm so as to obtain an accurate touch effect.

Furthermore, to improve the touch accuracy, the touched position is determined not only by detecting the change of capacitance on the touched touch sensing electrode, but also by considering an effect, caused by the touch object, on capacitance values of the touch sensing electrodes around the touched touch sensing electrode. When a touch object touches the touch sensing electrode, the touch object has a smallest effect on the capacitance of four touch sensing electrodes around the touched touch sensing electrode. The four touch sensing electrodes are located at the top, bottom, left and right of the touched touch sensing electrode. This condition can be considered to determine a relationship between the size of the touch object and the touched touch sensing electrode.

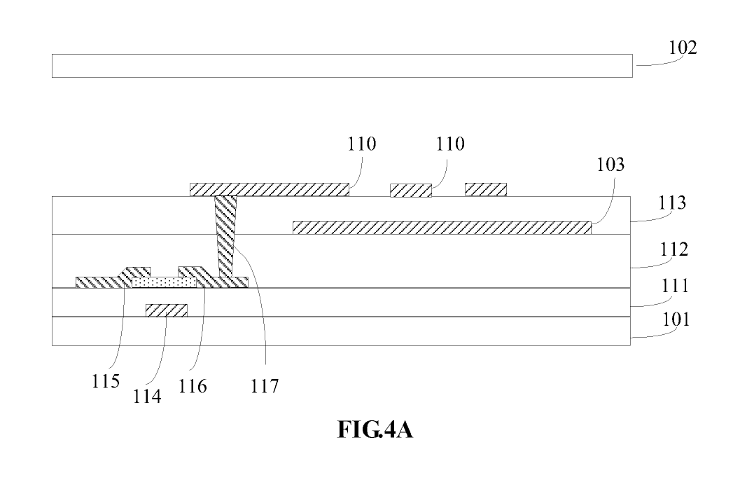

FIG. 3 is a partially schematic diagram showing a touch screen provided by the present disclosure. As shown in FIG. 3, nine touch sensing electrodes 310, which are arranged in an array, are numbered from one to nine. When the touched region (the touched region as represented by the shaded portion shown in FIG. 3) is touched against the touch sensing electrode 5 by the touch object, the touch object would have a same effect on capacitance of the four touch sensing electrodes 2, 4, 6 and 8 around the touch sensing electrode 5 as the touch object is close to the touch sensing electrode 5, so that only one of the four touch sensing electrodes is needed to be selected to measure the change of the capacitance thereof. A stimulation is made to the touch case shown in FIG. 3 to measure the capacitance of the touch sensing electrode 4 before the touch and after the touch, respectively, and the difference therebetween is obtained as the change of the capacitance of the touch sensing electrode 4 before the touch and after the touch, thereby finally obtaining a percentage ratio of the change of the capacitance to the capacitance of the touch sensing electrode 4 after the touch, which is referred as the percentage ratio of change of the capacitance. For different touch areas, the size of the touch sensing electrode can be adjusted to obtain a set of data shown in table 1 below. As shown in table 1, d represents a diameter of the touched region, D represents a side length of the square touch sensing electrode, measured in ‘mm’. Since computational accuracy is 0.50%, a value smaller than 0.50% is considered as an error. When the touch object is close to the touch sensing electrode, the value of capacitance on the touch sensing electrode should be increased, and hence the change of the capacitance should be a positive value. That is, the percentage ratio of change of the final capacitance should be also a positive value, and negative percentage ratio of change of the capacitance is represented as noise affection.

TABLE 1

| | d | | | | | | | | |
|---|---|---|---|---|---|---|---|---|---|
| D | 2 | 3 | 4 | 5 | 6 | 7 | 8 | 9 | 10 |
| 2 | 0.60% | 1.26% | 2.15% | 2.99% | 3.42% | 3.61% | 3.63% | 3.53% | 3.69% |
| 2.5 | 0.36% | 0.76% | 1.75% | 2.88% | 7.33% | 7.88% | 4.66% | 4.78% | 4.81% |
| 3 | 0.23% | 0.47% | 1.17% | 2.44% | 3.53% | 4.74% | 5.39% | 5.84% | 9.09% |
| 3.5 | −0.13% | 0.28% | 0.67% | 1.61% | 2.72% | 4.08% | 5.07% | 6.05% | 6.56% |
| 4 | 0.03% | −2.71% | 0.82% | 1.04% | 1.91% | 3.37% | 4.42% | 5.72% | 6.37% |
| 4.5 | −0.24% | 0.01% | 0.07% | 0.55% | 1.50% | 2.62% | 3.84% | 4.85% | 5.85% |
| 5 | 0.02% | 0.11% | 0.26% | 0.38% | 0.81% | 2.10% | 3.42% | 4.28% | 5.34% |
| 5.5 | 0.01% | 0.00% | 0.06% | 0.20% | 0.73% | 1.73% | 1.74% | 1.36% | 1.62% |
| 6 | 0.11% | 0.08% | 0.01% | 0.14% | 0.53% | 0.93% | 1.30% | 1.15% | 3.75% |
| 6.5 | −0.06% | 0.06% | 0.13% | −0.10% | 0.30% | 0.67% | 0.73% | 2.10% | 5.35% |
| 7 | −0.14% | −0.12% | −0.27% | −0.07% | −0.02% | 0.22% | 0.97% | 1.44% | 2.07% |
| 7.5 | 0.09% | 2.27% | −0.28% | 2.46% | 0.22% | −2.42% | 0.73% | 0.84% | 1.76% |
| 8 | −0.04% | −0.13% | 2.55% | 2.11% | −0.47% | −2.55% | 0.62% | 0.87% | 0.66% |
| 8.5 | −1.94% | 0.04% | 0.02% | 0.00% | −0.09% | 0.00% | −0.04% | 0.67% | 1.22% |
| 9 | −0.13% | −1.92% | −1.96% | 2.21% | 0.13% | −4.01% | 0.18% | 0.24% | 0.58% |
| 9.5 | 2.26% | 0.18% | 0.36% | 0.23% | 1.01% | 0.19% | 0.41% | 0.90% | 1.19% |
| 10 | 0.05% | 0.21% | −1.80% | −1.54% | −1.76% | −1.46% | −1.25% | −1.48% | 0.61% |

It can be seen from table 1 that the percentage ratio of the change of the capacitance on the touch sensing electrode 4 is substantially smaller than an accuracy value or a negative value when the side length of the touch sensing electrode is larger than the diameter of the touched region, presenting irregular change so that the percentage ratio of change of the capacitance cannot be used to determine the touched position. However, the percentage ratio of the change of the capacitance is larger than a positive value of the accuracy when the side length of the touch sensing electrode is smaller than the diameter of the touched region, and in the case of a same size of the touch sensing electrodes, the percentage ratio of the change of the capacitance tends to be substantially larger as the touched region is larger. Therefore, to use the change of the capacitance to accurately determine the touched position, the side length of the touch sensing electrode needs to be smaller than the diameter of the touched region. It can also be seen from table 1 that the capacitance on the touch sensing electrode 4 also has a considerable change when the side length of the touch sensing electrode is equal to the diameter of the touched region, but the percentage ratio of the change of the capacitance is unstable. For example, the percentage ratio sometime is larger than a positive value above than the accuracy and sometime is a positive value slightly below than the accuracy.

In the above stimulation, the touch sensing electrode is a square shape, the touched region is a circle shape, and the touched region is against to the touch sensing electrode 5. It can be obtained from the stimulation result that the side length of the touch sensing electrode needs to be smaller than the diameter of the touched region in order to use the change of the capacitance to accurately determine the touched position. In such case, the touched region would relate to four touch sensing electrodes 2, 4, 6 and 8 around the touch sensing electrode 5, and thus the change of the capacitance on the touch sensing electrode 5 is reasonable, i.e. regardless of the shape of the touch sensing electrode, the accuracy of the touched position can be improved if the touched region can relate to other touch sensing electrodes around the touch sensing electrode when the touched region is touched against the touch sensing electrode. Therefore, if the area of the touch sensing electrode is smaller than that of the touch area, it can be sure that one touch can relate to a plurality of touch sensing electrodes, thereby improving accuracy of the touched position. In the stimulation result, there is another case that the side length of the touch sensing electrode is equal to the diameter of the touched region, i.e. the touched region is just within the touch sensing electrode 5 and the change of the capacitance on the touch sensing electrode 4 is also considerable. Although it is unstable, such a case is considered as an extremely rare case in an actual touch process in which the touched region overlaps exactly with the touch sensing electrode, so that the case that the side length of the touch sensing electrode is equal to the diameter of the touched region is also applicable, i.e. the case that the area of the touch sensing electrode is equal to that of the touched region is also applicable. The area of the touched region is related to the touch object, such as the finger, so that the touched region touched by the finger can be different due to the diversity of the people and the diversity of the strength of the touch. Most of adults have index fingers with average width of 16 mm-20 mm, with generally a half of which touching the touch screen if it is touched gently, and the touched region is generally a circle having a diameter of 8 mm. Therefore, in order that the touch screen has a better touch accuracy, i.e. an accurate touch is achieved by slight touch of the finger, the side length of the touch sensing electrode is not larger than 8 mm, and hence the area of the touch sensing electrode is not larger than 64 mm² for the area of the touch sensing electrode. For the case that other touch objects touch the touch screen, the size of the touch sensing electrode can be determined by the area of the touched region usually achieved by the touch object. For example, in some case, it is desirable that the touch with higher accuracy can be achieved by a touch pen having a smaller touch head. In such case, the touch sensing electrode needs to be manufactured smaller, and the area of the touch sensing electrode is not larger than the touch area of the touch pen. Therefore, the area of the touched region can be understood as a range of touched region formed on the touch screen when a general touch is operated on the touch screen.

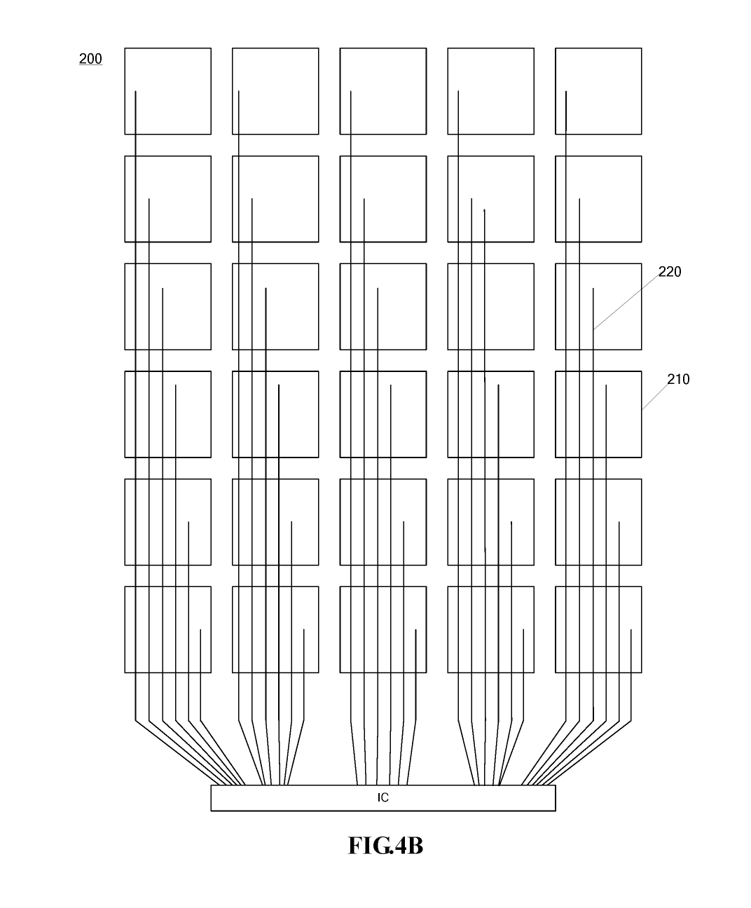

Another embodiment of the present disclosure further provides a touch display panel. FIG. 4A is a cross-sectional view of a touch display panel provided by the present disclosure. FIG. 4A mainly describes a display portion of the touch display panel. As shown in FIG. 4A, the touch display panel is a liquid crystal display panel. The touch display panel includes an array substrate and a color filter substrate 102. Liquid crystal molecules are filled between the array substrate and the color filter substrate 102 (not shown in FIG. 4A) and are rotated under the electric field to implement a display function.

The array substrate of the touch display panel of the present embodiment further includes:

a substrate 101;

a gate electrode 114 located on the substrate 101;

a first insulation layer 111 configured for covering the gate electrode 114;

a source electrode 115 and a drain electrode 116 located at one side of the first insulation layer 111 away from the substrate 101;

a second insulation layer 112 configured for covering the source electrode 115 and the drain electrode 116;

a common electrode 103 located at one side of the second insulation layer 112 away from the substrate 101;

a third insulation layer 113 covering the common electrode 103;

a pixel electrode 110 located at one side of the third insulation layer 113 away from the substrate 101; and

a first via hole 117 located in the second insulation layer 112 and the third insulation layer 113, wherein, the pixel electrode 110 is electrically connected with the drain electrode 116 by the first via hole 117.

A transistor can consist of the gain electrode 114, the source electrode 115 and the drain electrode 116 and can be used as a switch to control an electric potential of the pixel electrode 110.

FIG. 4B is a top view of a touch display panel provided by the present disclosure. FIG. 4B mainly describes a touch portion of the touch display panel. As shown in FIG. 4B, the touch display panel 200 includes: a plurality of touch sensing electrodes 210 arranged in an array and insulated from each other; a plurality touch sensing leads 220, each of which is electrically connected with one of the plurality of the touch sensing electrodes 210. The touch display panel 200 is a self-capacitive touch display panel. A touch sensing signal is outputted into the touch sensing electrode 210 via the touch sensing lead 220. When a finger is close to the touch sensing electrode 210, a coupling capacitor is formed between the finger and the touch sensing electrode 210 due to a human body electric field, and the formed coupling capacitor may cause a change of a capacitance of the touch sensing electrode 210 itself to the ground, it can be determined by detecting the change of the capacitance that the finger is close to which one (or some) of the touch electrodes 210, thereby determining touched position of the finger.

The display portion of the touch display panel provided by the embodiment shown in FIG. 4A can be combined with the touch portion of the touch display panel provided by the embodiment shown in FIG. 4B. The touch sensing electrodes and the touch sensing leads can be manufactured simultaneously on the substrate 101 shown in FIG. 4A in order to form the touch display panel without a limitation of the display portion of the touch display panel, for example, a Liquid Crystal Display (LCD), an Organic Light-Emitting Diode (OLED) or an Electric paper (E-paper) can be employed. When the display portion of the touch display panel uses the liquid crystal display, the touch sensing electrode can be further reused as the common electrode in the liquid crystal display in order to highly integrate the display portion with the touch portion. That is, an electrode component in the touch display panel functions as a touch sensing electrode or a common electrode. For example, the common electrode 103 in the touch display panel shown in FIG. 4A is also used as the touch sensing electrode. In order to make the electrode component to have two functions mentioned above, a time division driving manner can be implemented. During a touch stage, a touch signal is inputted and outputted into an electrode to achieve a touch function of the electrode; during a display stage, a common signal for display is inputted to the electrode to achieve the common electrode function, and an electric field is formed between the electrode and the pixel electrode of the touch display panel to control the rotation of the liquid crystal molecules for the display function.

The principle of setting the size of the touch sensing electrode in the touch display panel is similar to the principle of setting the size of the touch sensing electrode of the touch screen provided by the present disclosure and hence refers to the above embodiment, which is not repeatedly discussed herein. The number of the touch sensing electrodes, which can be set appropriately on the touch display panel, can be computed according to the principle of setting the size of the touch sensing electrode in the above embodiment and based on the size of the touch display panel.

The shape of an active touch display region of the touch display panel is not limited, and currently the active touch display region of the common touch display panel has a rectangle shape, the ratio of the length to the width of the rectangle shape is usually 16:9 or 16:10.

For a rectangle touch display panel of which the ratio of the length to the width of the rectangle shape is 16:9, and size is represented by “a” inch (where “a” is the length of diagonal of the rectangle touch display region, and is a positive value), the length of a long side of the rectangle touch display panel is

$$\frac{2032}{5 \sqrt{337}} a mm ,$$

for example about 22.14a mm. In a long side direction, the number of touch sensing electrodes is configured to be no more than an integer part of 13.84a and no less than an integer part of 2.77a; the length of a width side of the rectangle touch display panel is

$$\frac{1143}{5 \sqrt{337}} a mm ,$$

for example about 12.45a mm. In a width side direction, the number of touch sensing electrodes is configured to be no more than an integer part of 7.78a and no less than an integer part of 1.56a. The touch sensing electrodes are arranged in an array along the long side and width side of the rectangle touch display panel. For the rectangle touch display panel of which the ratio of the length to the width of the rectangle shape is 16:9 and the size is represented by “a” inch, the number of touch sensing electrodes is configured to be no more than an integer part of 107.67a2 and no less than an integer part of 4.32a2. Since the number of the touch sensing electrodes can only be a positive integer, an integer portion of 107.67a2 or an integer portion of 4.32a2+1 can be selected for extreme case.

Similarly, for a rectangle touch display panel of which the ratio of the length to the width of the rectangle shape is 16:10 and size is represented by “b” inch (where, “b” is the length of diagonal of the rectangle touch display region, and is a positive value), the length of a long side of the rectangle touch display panel is

$$\frac{2032}{10 \sqrt{39}} b mm ,$$

such as about 21.54b mm. According to above requirement of the accurate touch identification, in a long side direction, the number of touch sensing electrodes is configured to be no more than an integer part of 13.46b and no less than an integer part of 2.69b; the length of a width side of the rectangle touch display panel is

$$\frac{254}{2 \sqrt{89}} b mm ,$$

such as about 13.46b mm, and in a width side direction, the number of touch sensing electrodes is configured to be no more than an integer part of 8.41b and no less than an integer part of 1.68b. Therefore, the touch sensing electrodes are arranged in an array along the long side and width side of the rectangle touch display panel. For the rectangle touch display panel of which the ratio of the length to the width of the rectangle shape is 16:10 and the size is represented by “b” inch, the number of touch sensing electrodes is configured to be no more than an integer part of 113.24b² and no less than an integer part of 4.52b². Since the number of the touch sensing electrodes can only be a positive integer, an integer portion of 113.24b² or an integer portion of 4.52b²+1 can be selected for extreme case.

Illustratively, the shape of the active touch display being a rectangle as described above is an example. It is noted that irregular touch display region has been applied widely more and more recently. For the touch display panel including irregular touch display region, it usually includes a touch display region with a rectangle shape and a touch display region with other irregular shape. For the touch display region with a rectangle shape, the size thereof is presented by “p” inch (where, p is the length of diagonal of the rectangle touch display region, and is a positive value), the number of touch sensing electrodes included in the rectangle touch display region is no less than 3.175p but no more than or equal to 126p². Particularly, for the rectangle touch display region of which the size is presented by “p” inch, the area thereof is the largest if the rectangle is a square shape. In such a case, if the size of the touch sensing electrode is the minimum value that can be used as described above, the number of the touch sensing electrodes, which can be set on the rectangle touch display region with a size of “p” inch, is the maximum value; and conversely, if the rectangle touch display region with the size of “p” is a narrow and elongated rectangle region, the area thereof is relative small. In such a case, if the size of the touch sensing electrode is the maximum value that can be used as described above, the number of the touch sensing electrode, which can be set on the rectangle touch display region with the size of “p” inch, is minimum. For the narrow and elongated rectangle touch display region, only one touch sensing electrode can be set on the short side of the rectangle, the long side of the rectangle is about “p” inch, and thus the minimum of the number of the touch sensing electrodes is larger than or equal to 3.175p.

The limitation to the number of the touch sensing electrodes on the touch display panel provided by the above embodiment is likewise adapted to the limitation to the number of the touch sensing electrodes on the touch screen of the present disclosure.

In addition that the change of the capacitance on the touch sensing electrode can affect size and shape of the touch sensing electrodes on the touch display panel thereby affecting the number of the touch sensing electrodes provided on the touch display panel, the number of the touch sensing leads can also limit that of the touch sensing electrodes. Each of the touch sensing electrodes needs to be electrically connected with at least one of the touch sensing leads, and each of the touch sensing leads needs to be individually connected to the integration circuit portion to obtain a touch signal or a common signal for display. Especially when the border of the touch display panel needs to be narrow, the space to set the touch sensing leads is limited, and in the meantime manufacturing process conditions, the requirement to the size of the resistance of the touch sensing leads and the setting manner of the touch sensing leads all can affect the width of the touch sensing leads and the limited number of the touch sensing leads which can be set within limited space. When a touch sensing lead is simultaneously electrically connected with a plurality of electrodes separated and insulated from each other, since touch signals inputted into or outputted from the plurality of electrode herein are the same, the plurality of electrodes can be entirely considered as a touch sensing electrode.

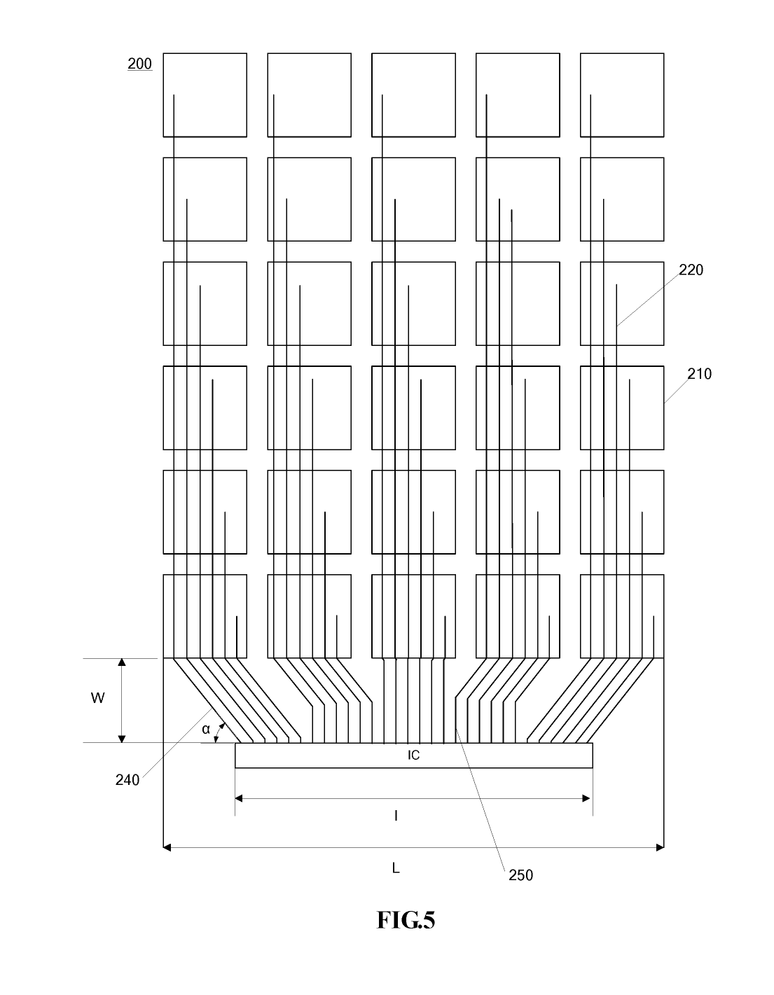

FIG. 5 shows an arrangement manner of touch sensing leads provided by an embodiment of the present disclosure. As shown in FIG. 5, the touch display panel 200 has a rectangle shape, and further includes a driving circuit (such as, an integrated circuit portion IC). One end of the touch sensing lead 220 is electrically connected with the touch sensing electrode 210, and the other end of the touch sensing lead 220 is electrically connected with the integrated circuit portion IC. The integrated circuit portion IC is a strip shape, and the long side of the integrated circuit portion IC is configured to be parallel to a first side of the touch display panel 200. If L represents the length of the first side of the touch display panel 200 which is located within the active touch display region, W represents a distance from the edge of the active touch display region of the touch display panel 200 to the integrated circuit portion IC, d represents a distance between two adjacent touch sensing leads, then the number of the touch sensing leads is smaller than or equal to

$$\frac{L - \sqrt{{L}^{2} - 8 W}}{2 d} .$$

We assumed that the number of the touch sensing leads is x, the length of long side of the integrated circuit portion IC is 1. It is necessary to provide the enough space to arrange all touch sensing leads in the direction of the long side of the integrated circuit portion IC so that all touch sensing leads can be connected to the integrated circuit portion IC. Therefore, the length 1 of the long side of the integrated circuit portion IC cannot be smaller than xd, and is further related to the number of pins of the integrated circuit portion IC to which the touch sensing leads can be connected, and the number of the touch sensing leads 220 cannot be larger than that of pins of the integrated circuit portion IC to which the touch sensing leads can be connected. The number of pins of the integrated circuit portion IC is not discussed herein. Generally, the integrated circuit portion IC is provided at the middle of the first side of the touch display panel 200. Since the length 1 of the long side of the integrated circuit portion IC is smaller than the length L of the first side of the touch display panel 200 in the active touch display region, the touch sensing leads need to be connected to the integrated circuit portion IC in a fold line manner. As shown in FIG. 4, the left-most and right-most touch sensing leads 220 are directly connected to the integrated circuit portion IC by slanted lead lines 240, and in order to make full use of the space between the active touch display region and the integrated circuit portion IC, other (i.e., remaining) touch sensing leads 220 are likewise led out by the leads lines 240 having the same slope. The lead lines 240 of the touch sensing lead 220 on the left are parallel to the left-most lead line 240 of the touch sensing lead 220, the lead lines 240 of the touch sensing lead 220 on the right are parallel to the right-most lead line 240 of the touch sensing lead 220. The touch sensing lead 220 is led out by the lead line 240, and thereafter is connected to the integrated circuit portion IC by a connection line 250 perpendicular to the integrated circuit portion IC, thereby facilitating a convenience of the layout design. In such a connection manner, the lead lines 240 led out from the touch sensing leads 220 outside two terminal portions of the integrated circuit portion IC can be arranged within a distance W, and thus

$$\frac{L - 1}{2 cos α} xd \leq W$$

In an extreme case,

$$\frac{L - xd}{2 } xd \leq W$$

Finally It can be obtained that

$$x \leq \frac{L - \sqrt{{L}^{2} - 8 W}}{2 d}$$

Therefore, the number of the touch sensing leads 220 is smaller than or equal to

$$\frac{L - \sqrt{{L}^{2} - 8 W}}{2 d} .$$

Since one touch sensing lead 220 can be at most connected to one touch sensing electrode 210, the number of the touch sensing electrodes 210 is also smaller than or equal to

$$\frac{L - \sqrt{{L}^{2} - 8 W}}{2 d} .$$

For the touch screen provided by the present disclosure, if the arrangement of the touch sensing leads of the touch screen is the same as the arrangement shown in FIG. 5, then

$$\frac{L - \sqrt{{L}^{2} - 8 W}}{2 d}$$

can be used to limit the number of the touch sensing leads of the touch screen.

It should be noted that the above description only describes preferable embodiments and technical principles of the present invention. Those skilled in this art will understand that the present invention is not limited to the specific embodiments described herein, and various apparent changes, rearrangements and substitutions may be made by those skilled in this art without departing from the protecting scope of the present invention. Therefore, although the present invention has been described in detail as above in connection with the embodiments, the present invention is not to limit thereto and may include other equivalent embodiments without departing from the conception of the present invention. However, the protecting scope of the present invention is defined by the following appended claims.

1. A touch screen, the touch screen being a self-capacitive touch screen and comprising:
a plurality of touch sensing electrodes arranged in an array and insulated from each other; and
a plurality of touch sensing leads, each of which is electrically connected with one of the touch sensing electrodes; and, wherein
there is a rectangle active touch region in the touch screen such that a total number of the touch sensing electrodes within the rectangle active touch region is larger than or equal to 3.175p and is smaller than or equal to 126p²,
wherein p represents a size of the rectangle active touch region, is in a unit of inch and is a positive integer.

2. The touch screen of claim 1, wherein, an area of each of the touch sensing electrodes is larger than or equal to 2.56 mm².

3. The touch screen of claim 1, wherein, each of the touch sensing electrodes has a rectangle shape and a length and a width thereof are both larger than or equal to 1.6 mm.

4. The touch screen of claim 1, wherein, an area of each of the touch sensing electrodes is smaller than or equal to that of a touched region.

5. The touch screen of claim 1, wherein, an area of each of the touch sensing electrodes is smaller than or equal to 64 mm².

6. The touch screen of claim 1, wherein, each of the touch sensing electrodes has a rectangle shape, and a length and a width thereof are both smaller than or equal to 8 mm.

7. The touch screen of claim 1, wherein the touch screen has a rectangle shape, the integrated circuit portion has a strip shape, a long side of the integrated circuit portion is provided parallel to a first side of the touch screen, and wherein
a total number of the touch sensing leads is smaller than or equal to
$$\frac{L - \sqrt{{L}^{2} - 8 W}}{2 d} ,$$
wherein L represents a length of the first side of the touch screen which is located within the active touch display region, W represents a distance from an edge of the active touch display region of the touch screen to the integrated circuit portion, and d represents a distance between two adjacent touch sensing leads.

8. A touch display panel, the touch display panel being a self-capacitive touch display panel and comprising a display portion and a touch portion, wherein the touch portion comprises:
a plurality of touch sensing electrodes arranged in an array and insulated from each other; and
a plurality of touch sensing leads, each of which is electrically connected with one of the touch sensing electrodes; and, wherein
the touch display panel comprises a rectangle active touch display region, wherein
there is a rectangle active touch region in the touch screen such that a total number of the touch sensing electrodes within the rectangle active touch region is larger than or equal to 3.175p and is smaller than or equal to 126p²,
wherein p represents a size of the rectangle active touch region, is in a unit of inch and is a positive integer.

9. The touch display panel of claim 8, wherein, the touch sensing electrode is reused as a common electrode, a touch signal is inputted into and outputted from the touch sensing electrode during a touch stage, and a display common signal is inputted into the touch sensing electrode during a display stage.

10. The touch display panel of claim 8, wherein, an area of each of the touch sensing electrodes is larger than or equal to 2.56 mm².

11. The touch display panel of claim 8, wherein, each of the touch sensing electrodes has a rectangle shape, and a length and a width thereof are both larger than or equal to 1.6 mm.

12. The touch display panel of claim 8, wherein, an area of each of the touch sensing electrodes is smaller than or equal to 64 mm².

13. The touch display panel of claim 8, wherein, each of the touch sensing electrodes has a rectangle shape, and a length and a width thereof are both smaller than or equal to 8 mm.

14. The touch display panel of claim 8, wherein, the ratio of the length to the width of the rectangle active touch display region of the touch display panel is 16:9, and hence
a total number of the touch sensing electrodes within the rectangle active touch display region is larger than or equal to 4.32a²,
where a represents a size of the rectangle active touch display region, is in a unit of inch and is a positive value.

15. The touch display panel of claim 8, wherein, the ratio of the length to the width of the rectangle active touch display region of the touch display panel is 16:9, and hence
a total number of the touch sensing electrodes within the rectangle active touch display region is smaller than or equal to 107.67a²,
where a represents a size of the rectangle active touch display region, is in a unit of inch, and is a positive value.

16. The touch display panel of claim 8, wherein, the ratio of the length to the width of the rectangle active touch display region of the touch display panel is 16:10, and hence
a total number of the touch sensing electrodes within the rectangle active touch display region is larger than or equal to 4.52b²,
where b represents a size of the rectangle active touch display region, is in a unit of inch and is a positive value.

17. The touch display panel of claim 8, wherein, the ratio of the length to the width of the rectangle active touch display region of the touch display panel is 16:10, and hence
a total number of the touch sensing electrodes within the rectangle active touch display region is smaller than or equal to 113.24b²,
where b represents a size of the rectangle active touch display region, is in a unit of inch and is a positive value.

18. The touch display panel of claim 8, wherein the touch display panel has a rectangle shape, the integrated circuit portion has a strip shape, a long side of the integrated circuit portion is provide parallel to a first side of the touch display panel, and wherein
a total number of the touch sensing leads is smaller than or equal to
$$\frac{L - \sqrt{{L}^{2} - 8 W}}{2 d} ,$$
where L represents a length of the first side of the touch display panel in the active touch display region, W represents a distance from an edge of the active touch display region of the touch display panel to the integrated circuit portion, and d represents a distance between two adjacent touch sensing leads, and

19. A touch device, comprising the touch screen of claim 1.

20. A touch device, comprising the touch display panel of claim 8.
